(19) United States
(12) Patent Application Publication
(10) Pub. No.: US 2003/0033294 A1
(43) Pub. Date: Feb. 13, 2003

(54) Method and apparatus for marketing supplemental information

(76) Inventors: Jay S. Walker, Ridgefield, CT (US); Jose A. Suarez, Fairfield, CT (US); Norman A. Goldstein, Scarsdale, NY (US); James A. Jorasch, Stamford, CT (US); Peter F. Burgess, Stamford, CT (US); Geoffrey M. Gelman, Stamford, CT (US); Steven M. Santisi, Ridgefield, CT (US)

Correspondence Address: WALKER DIGITAL, FIVE HIGH RIDGE PARK, STAMFORD, CT, 06905, US

(21) Appl. No.: 10/123,634

(22) Filed: Apr. 15, 2002

Related U.S. Application Data
(60) Provisional application No. 60/283,798, filed on Apr. 13, 2001.

(51) Int. Cl. G06F 7/00

(52) U.S. Cl. 707/3

(57) ABSTRACT

The invention includes a process for creating recordings according to a protocol such that tags are inserted into the recording to identify characteristics of the content of the recording. Further, the invention provides a method for redacting the recording using the inserted tags to generate a saleable version of the recording. The tags are used to exclude certain inappropriate content and to generate meta-data regarding the recording. Some embodiments of the invention include a recording device, a controller, and a user device. The recording device may be used to record an interview session between an interviewer and an interviewee. The recording device may communicate with the controller to convey the raw transcript of the interview session. The controller may include redacting software for modifying the interview transcript, and a voice recognition module for assisting in the redaction process. The voice recognition module may also assist in the creation of meta-tags describing the modified recording of the interview. The controller may further comprise a server for hosting Web pages. A user device in communication with the controller via the Internet may allow a user to peruse Web pages displaying the meta-tags and links that allow purchase of copies of associated interesting portions of the redacted interview transcripts as hosted by the controller.

### RELATED APPLICATIONS

This application claims priority to commonly-owned, co-pending U.S. Provisional Patent Application No. 60/283,798, filed Apr. 13, 2001, entitled “Hyper Footnote Software”; which is incorporated herein by reference in its entirety for all purposes.

This application is related to commonly owned, co-pending U.S. Patent Application Ser. No. 09/422,719, filed Oct. 22, 1999, entitled “Method And Apparatus For Distributing Supplemental Information Related To Printed Articles”, all of which is incorporated herein by reference in its entirety for all purposes.

### FIELD OF THE INVENTION

The present invention relates to methods and apparatus for organizing and selling information. More specifically, the present invention relates to obtaining, filtering, storing, arranging, displaying, selling, and/or providing access to information that may be pertinent to a primary (or summary) document but may only be referenced or partially included in the primary document.

### BACKGROUND OF THE INVENTION

News organizations expend substantial effort and expense to gather information for stories. Stories are typically presented in the form of newspaper articles, magazine articles, radio sound bites, or television news clips. Frequently, using these forms of media, there are time or space constraints on the presentation of the story such that much of the supplemental and source information gathered for the story is not used or even made available to interested parties.

Readers of news articles and viewers of television news stories often desire to learn more about the news topic. If the information pertains to the business of the reader, then further details on the subject may have significant business value for the reader. For example, a company executive may read an article about an upcoming advertising campaign of the company's main competitor. The potential business value of learning more about the competitor's advertising campaign could be enormous. The executive would be highly motivated to find out more information, and likely be willing to pay a substantial fee for the additional information.

A raw transcript of an interview typically cannot be made available to the public. This is because an interviewee may make statements “off the record,” or there may be inappropriate content in the interview transcript. Therefore, if an interview is to be made publicly available, the raw transcript must be modified. However, the modifying of a raw transcript may be a tedious and time consuming manual process, particularly if for example, there are many small segments that are off the record. Thus, systems and methods are needed for modifying the raw transcript of an interview without creating significant new time commitments or responsibilities for a journalist or an editor. What is further needed are systems and methods to profitably disseminate the modified transcripts.

### SUMMARY OF THE INVENTION

The disclosed invention solves the above and other drawbacks of the prior art by providing a system for obtaining, storing, displaying, and selling information that is pertinent to a document or other presentation of information, but may not be fully contained in the document. According to some embodiments of the present invention, an interviewer, for example, conducts an interview according to a protocol, making a recording of the interview. After the interview, the recording is analyzed and then, using tags inserted according to the protocol and identified in the analysis, is redacted by the system of the present invention.

Among other things, the system achieves two tasks. One is the elimination of portions of the interview that are unacceptable to the interviewee, the interviewer, and/or the editor of the paper (or other entity) for which the interview was conducted. Examples of unacceptable content include portions of the interview that are understood to be off the record and/or portions of the interview that contain vulgar language. The second task is to represent the interview to a potential information consumer in a salable format. Thus, in some embodiments the system may extract from the transcript the questions that were asked, transcribe them into text, and display them on a web page. A consumer who is considering paying to listen to the interview may then review the questions that were asked before committing to purchase the interview recording. The system may also divide the transcript into smaller portions, each portion corresponding to a single question and answer. That way, a consumer may pay to receive only the answers that interest him. Along with other information about the interview, the system may determine and display the length of the entire interview or of the smaller portions of it. The length of the interview may then be another factor made available for a purchaser to consider before paying to receive a recording of the interview.

The system analyzes the interview based on tags interspersed in the transcript of the interview as a result of the interviewer following the protocol mentioned above. Tags include words or phrases such as “question” or “off the record.” When the system encounters such tags in its analysis, the subsequent portion of the transcript is processed according to predefined rules. For example, when encountering an “off the record” tag, the system may eliminate the ensuing portion of the transcript, until encountering an “on the record” tag.

In some embodiments, once the interview has been conducted and the raw transcript has been redacted, the interview may be referenced in a news article. For example, a quote from the interviewee may be followed by a superscript numeral. At the end of the article, a footnote may list the same numeral with a link to a Web site containing the full audio and/or video transcript of the interview from which the quote was derived. In some embodiments, access to the link may be restricted to paying customers.

With these and other advantages and features of the invention that will become hereinafter apparent, the nature of the invention may be more clearly understood by reference to the following detailed description of the invention, the appended claims and to the several drawings included herein.

### BRIEF DESCRIPTION OF THE DRAWINGS

FIG. 1A is a block diagram illustrating an example system according to some embodiments of the present invention.

FIG. 1B is a block diagram illustrating an example system according to some alternative embodiments of the present invention.

FIG. 2 is a block diagram illustrating an example of a controller 102 as depicted in FIGS. 1A and 1B according to some embodiments of the present invention.

FIG. 3 is a block diagram illustrating an example of a recording device 106 as depicted in FIGS. 1A and 1B according to some embodiments of the present invention.

FIG. 4 is a block diagram illustrating an example of a user device 104 as depicted in FIGS. 1A and 1B according to some embodiments of the present invention.

FIG. 5 is an example illustration of a web page depicting an example display of supplemental information being made available for sale according to some embodiments of the present invention.

FIG. 6 is a table illustrating an example data structure of an example rules of engagement database 208 as depicted in FIG. 2 for use in some embodiments of the present invention.

FIG. 7 is a table illustrating an example data structure of an example of interview database 210 as depicted in FIG. 2 for use in some embodiments of the present invention.

FIG. 8 is a table illustrating an example data structure of an example interview questions database 212 as depicted in FIG. 2 for use in some embodiments of the present invention.

FIG. 9 is a table illustrating an example data structure of an example user database 214 as depicted in FIG. 2 for use in some embodiments of the present invention.

FIG. 10 is a flow diagram illustrating an exemplary process for preparing supplemental information for sale according to and for use in some embodiments of the present invention.

FIGS. 11A to 11D are a flow diagram illustrating details of an exemplary process for performing a redaction Step S3 as depicted in FIG. 10 according to and for use in some embodiments of the present invention.

### DETAILED DESCRIPTION OF THE INVENTION

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that structural, logical, software, and electrical changes may be made without departing from the scope of the present invention. The following description is, therefore, not to be taken in a limited sense, and the scope of the present invention is defined by the appended claims.

Applicants have recognized that a need exists for systems and methods to allow consumers of news to access further information of interest to them. The present invention allows a potential purchaser of an interview transcript to view information about the interview before deciding whether to make the purchase. Such information may include, for example, the questions asked and the length of the answers to the questions. Further, without requiring substantial expense or significant alteration of existing journalism methods, the present invention facilitates increased revenue for news organizations or other entities from sales of supplementary news or other information. In addition, the present invention provides an efficient, automated, low cost method of redacting inappropriate content from raw transcripts making the transcripts publicly saleable and thus, more valuable.

A. Definitions

Throughout the description that follows and unless otherwise defined, the following terms will refer to the meanings provided in this section. These terms are provided to clarify the language selected to describe the embodiments of the invention both in the specification and in the appended claims.

The terms “products,” “goods,” “merchandise,”0 and “services” shall be synonymous and refer to anything licensed, leased, sold, available for sale, available for lease, available for licensing, and/or offered or presented for sale, lease, or licensing including packages of products, subscriptions to products, contracts, information, services, and intangibles.

The term “merchant” shall refer to an entity who may offer to sell, lease, and/or license one or more products to a consumer (for the consumer or on behalf of another) or to other merchants. For example, merchants may include sales channels, individuals, companies, manufacturers, distributors, direct sellers, re-sellers, and/or retailers. Merchants may transact out of buildings including stores, outlets, malls and warehouses, and/or they may transact via any number of additional methods including mail order catalogs, vending machines, online web sites, and/or via telephone marketing. Note that a producer or manufacturer may choose not to sell to customers directly and in such a case, a retailer may serve as the manufacture's or producer's sales channel.

The term “user device” shall refer to any owned or used by a consumer capable of accessing and/or displaying online and/or offline content. Such devices may include gaming devices, personal computers, personal digital assistants, point of sale terminals, point of display terminals, kiosks, telephones, cellular phones, automated teller machines (ATM), etc.

The term “gaming device” shall refer to any gaming machine, including slot machines, video poker machines, video bingo machines, video keno machines, video blackjack machines, video lottery terminal, arcade games, game consoles, personal computers logged into online gaming sites, etc. Gaming devices may or may not be owned by a casino and/or may or may not exist within a casino.

The term “controller” shall refer to a device that may be in communication with third-party servers, and/or a plurality of user devices, and may be capable of relaying communications to and from each.

The term “input device” shall refer to a device that is used to receive an input. An input device may communicate with or be part of another device (e.g. a user device, a third-party server, a controller, etc.). Some examples of input devices include: a bar-code scanner, a magnetic stripe reader, a computer keyboard, a point-of-sale terminal keypad, a touch-screen, a microphone, an infrared sensor, a sonic ranger, a computer port, a video camera, a digital camera, a GPS receiver, a motion sensor, a radio frequency identification (RFID) receiver, a RF receiver, a thermometer, a pressure sensor, and a weight scale.

The term “output device” shall refer to a device that is used to output information. An output device may communicate with or be part of another device (e.g. a user device, a third-party server, a controller, etc.). Some examples of output devices include: a cathode ray tube (CRT) monitor, liquid crystal display (LCD) screen, light emitting diode (LED) screen, a printer, an audio speaker, an infra-red transmitter, a radio transmitter, etc.

The term “I/0 device” shall refer to any combination of input and/or output devices.

The term “redaction” shall refer to a process by which an interview transcript or other information source is modified. A redaction process may eliminate portions of an interview that, for example, are off the record, contain inappropriate language, and/or are intended for a restricted audience. A redaction process may add additional content or additional information regarding the information source.

The term “rules of engagement” shall refer to a protocol that may be followed by an interviewer and/or an interviewee. The protocol describes how the interviewer may use information obtained during the interview, and how the use may be signaled. For example, as part of a set of rules of engagement, an interviewer may agree to not make certain information available to the public. The interviewee may signal what information should not be made publicly available by prefacing the information with an “off the record” tag. In some embodiments, a set of tags to be used for a recording completely defines a given rules of engagement protocol.

The term “tag” shall refer to information used for redaction. In some embodiments, a tag may include a voiced word or phrase, such as “off the record” and in some embodiments a tone, a beep, and/or other audio visual signal maybe used. In the process of redaction, the system of the present invention may recognize the tag “off the record,” and consequently not include an associated portion of a raw transcript in a modified transcript of an interview.

Other tags may be used to convey other information to a redacting system. Such tags may include, for example, “end interview,” “on the record,” “question,” “end question,” “for attribution,” “not for attribution,” etc. The end interview tag may be, for example, voiced by a journalist during the course of a recorded interview so as to alert a redacting system that the interview is over. Likewise, an end question tag may be voiced by a journalist during the course of an interview so as to alert the redacting system that the journalist has just finished asking a question. A for attribution tag may be used, for example, to indicate that an associated portion of an interview may be permitted to be publicly attributed to the interviewee.

The term “meta-tag” shall refer to information about an interview or other information source. A meta-tag may include the length of the interview, the questions that were asked, the interviewee's name, the subject of the interview, and so on. Meta-tags may allow a potential purchaser of the interview to review information about the interview before deciding to commit time or money to listening to the interview. The term “meta-tag” is used distinctly from the term “tag” in that the former refers to information that may be displayed to a potential purchaser, while the latter refers to information that may be used in the redacting the interview transcript or other information source.

B. System

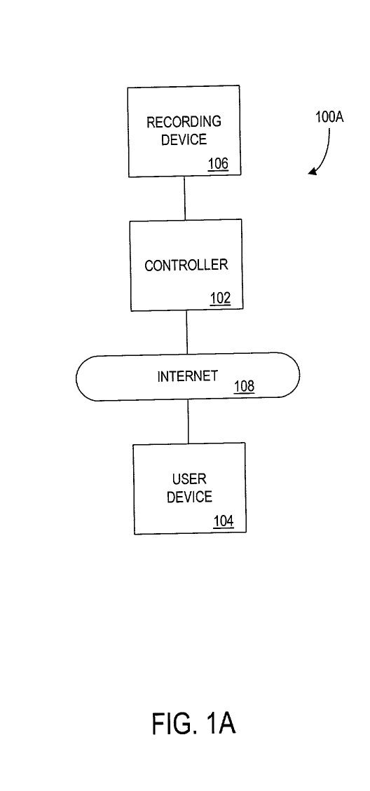

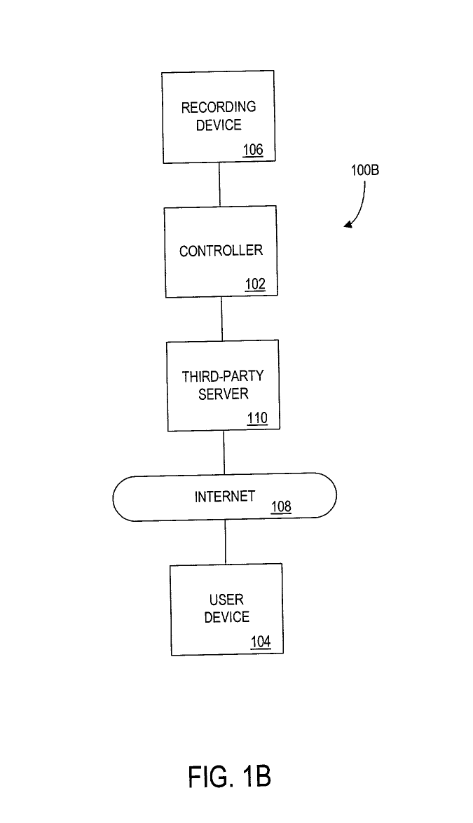

Referring now to FIG. 1A, a system 100 A according to some embodiments of the present invention includes a controller 102 that is in one or two-way communication via the Internet 108 (or other communications link) with one or more user devices 104 and/or recording devices 106. In operation, the controller 102 may function under the control of a merchant or other entity that may also control the recording devices 106. For example, the controller 102 may be a server in a newspaper's reporting network, a server in a television station's network, or a server in an information merchant's (e.g. LEXIS®) online network. In some embodiments, the controller 102 and the recording device 106 may be one and the same.

Referring to FIG. 1B, an alternative system 100B according to some other embodiments of the present invention further includes one or more third party servers 110. A third-party server 110 may also be in one or two-way communication with the controller 102. However, as shown in the embodiment depicted in FIG. 1B, the third-party server 110 may be disposed between the controller 102 and the user devices 104. In some embodiments, controller 102 may include multiple servers, each under the control of different entities. In such an embodiment, the third-party server 100 may function as a consolidator of the information products of the entities operating the plurality of controller servers.

The primary difference between the two alternative embodiments depicted in FIGS. 1A and 1B is that the embodiment of FIG. 1B includes the third-party server 110 which may be operable by an entity both distinct and physically remote from the entity operating the controller 102. In operation, the third-party server 110 may perform the methods of the present invention by sending signals to the controller 102 relayed from the user devices 104. In such an embodiment, the third-party server 110 may function as a reseller of information owned or controlled by the controller 102. For example, an information merchant may operate a third party server 110 that communicates with a news organization's server (functioning as a controller 102 ) to provide consumers, via user devices 104, with fee-based access to redacted recordings of interviews. In the embodiment of FIG. 1A, the functions of the third-party server 110 may be consolidated into the controller 102.

An additional difference between the two embodiments depicted in FIGS. 1A and 1B relates to the physical topology of the system 100A, 100B. In both of the embodiments, each node may securely communicate with every other node in the system 100A, 100B via, for example, a virtual private network (VPN). Thus, all nodes may be logically connected. However, the embodiment depicted in FIG. 1B allows the third-party server 110 to serve as a single gateway between the nodes that will typically be operated by the owners of the information and the other nodes in the system 100B, ie. nodes that may be operated by consumers of the information products.

In some embodiments, the recording devices 106 may each be controlled by different information merchants. The controller 102 may be operated by an entity that uses the present invention to, for example, serve as an information repository such as a commercial library. If there is a third-party server 110, it may be operated by an unrelated entity that merely permits the operators of the controller 102 to have access to consumers who are operating the user devices 104. Thus, in such an example embodiment, the system of the present invention may involve information merchants (operating recording devices 106 ), a customer acquisition service agent (operating the controller 102 ), third party network operators (operating third party servers 110 ), and consumers (operating user devices 104 ). In alternative embodiments, a merchant may operate a combined controller/recording device directly and the system may only involve an information merchant and a consumer.

In both embodiments pictured in FIGS. 1A and 1B, communication between each of the controller 102, the recording devices 106, the user devices 104, and/or the third party server 110, may be direct and/or via a network such as the Internet 106.

Referring to both FIGS. 1A and 1B, each of the controller 102, (the third-party server 110,) the recording devices 106, and the user devices 104 may comprise computers, such as those based on the Intel® Pentium® processor, that are adapted to communicate with each other. Any number of third party servers 110, recording devices 106, and/or user devices 104 may be in communication with the controller 102. In addition, the user devices 104 may be in one or two-way communication with the third-party server 110. The controller 102, the third-party server 110, the recording devices 106, and the user devices 104 may each be physically proximate to each other or geographically remote from each other. The controller 102, the third-party server 110, the recording devices 106, and the user devices 104 may each include input devices (not pictured) and output devices (not pictured).

As indicated above, communication between the controller 102, the third-party server 110, the recording devices 106, and the user devices 104, may be direct or indirect, such as over an Internet Protocol (IP) network such as the Internet 108, an intranet, or an extranet through a web site maintained by the controller 102 (and/or the third-party server 110) on a remote server or over an online data network including commercial online service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 108 may not transmit data to the other device for weeks at a time. The nodes of the system 100A, 100B may not remain physically coupled to each other. For example, the recording device 106 may only be connected to the system 100A, 100B when an interviewer has a raw interview transcript to upload to the controller 102.

The controller 102 (and/or the third-party server 110) may function as a “web server” that presents and/or generates web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A Web server allows communication with the controller 102 in a manner known in the art. The recording devices 106 and the user devices 104 may use a Web browser, such as NAVIGATOR® published by NETSCAPE® for accessing HTML forms generated or maintained by or on behalf of the controller 102 and/or the third-party server 110.

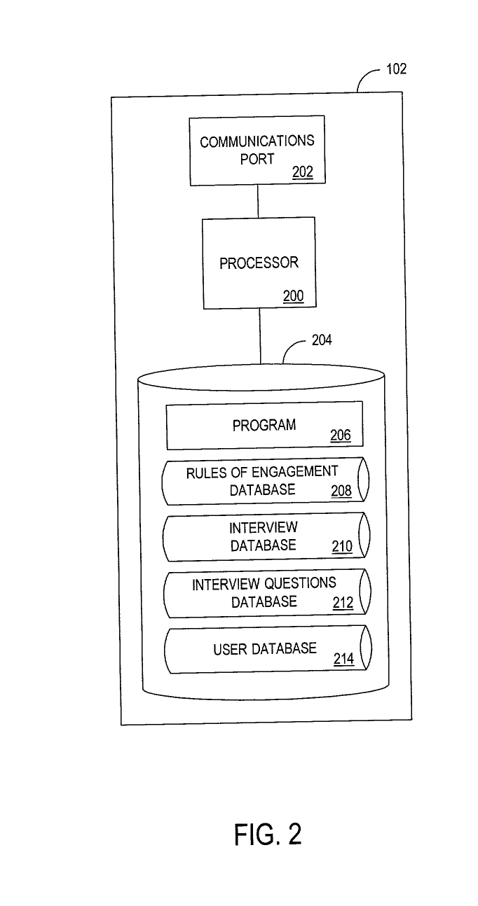

As indicated above, any or all of the controller 102, the third-party server 110, the recording devices 106 and the user devices 104 may include, e.g., processor based cash registers, telephones, interactive voice response (IVR) systems such as the ML400-IVR® designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (PDA). Further details of the controller 102, the recording devices 106, and the user devices 104 are provided below with respect to FIGS. 2 through 4.

As indicated above, in some embodiments of the invention the controller 102 (and/or the third-party server 110) may include recording devices 106, and/or user devices 104. Further, the controller 102 may communicate with interviewers (information suppliers) directly instead of through the recording devices 106. Likewise, the controller 102 may communicate with consumers directly instead of through the user devices 104. Although not pictured, the controller 102, the third-party server 110, the recording devices 106, and the user devices 104 may also be in communication with one or more consumer and/or merchant credit institutions to effect transactions and may do so directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

In operation, the recording device may be used to record an interview between a interviewer and an interviewee. Further, the recording devices 106 may transmit recordings to the controller 102 and the controller 102 may transmit redacted recordings to the user devices 104. In embodiments with a third-party server 110, the recording devices 106 may transmit recordings to the controller 102, the controller 102 may transmit the recordings to the third-party server 110, and the third-party server 110 may transmit redacted recordings to the user devices 104. Alternatively, the controller 102 may transmit redacted recordings to the third-party server 110. The user devices 104 may provide consumer information to the controller 102 (and/or the third-party server 110). The controller 102 (and/or the third-party server 110) may execute online transactions with consumers via user devices 104 operated by consumers. A user device 104 in communication with the controller 102 via the Internet 108 may be used to peruse Web pages hosted by the controller 102 displaying data regarding redacted interview transcripts that are available for purchase.

C. Devices

FIG. 2 is a block diagram illustrating details of an example of the controller 102 of FIGS. 1A and 1B (and/or the third-party server 110 of FIG. 1B). The controller 102 is operative to manage the system and execute the methods of the present invention. The controller 102 may be implemented as one or more system controllers, one or more dedicated hardware circuits, one or more appropriately programmed general purpose computers, or any other similar electronic, mechanical, electro-mechanical, and/or human operated device. For example, in FIG. 1B, the controller 102 is depicted as coupled to a third-party server 110. In the embodiment of FIG. 1B, these two servers may provide the same functions as the controller 102 alone in the embodiment of FIG. 1A.

The controller 102 (and/or the third-party server 110) may include a processor 200, such as one or more Intel® Pentium® processors. The processor 200 may include or be coupled to one or more clocks or timers (not pictured), which may be useful for determining information relating to, for example, a length of a recording, and one or more communications ports 202 through which the processor 200 communicates with other devices such as the recording devices 106, the user devices 104 and/or the third-party server 110. The processor 200 is also in communication with a data storage device 204. The data storage device 204 includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 200 and the storage device 204 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the controller 102 may comprise one or more computers (or processors 200) that are connected to a remote server computer operative to maintain databases, where the data storage device 204 is comprised of the combination of the remote server computer and the associated databases.

The data storage device 204 stores a program 206 for controlling the processor 200. The processor 200 performs instructions of the program 206, and thereby operates in accordance with the present invention, and particularly in accordance with the methods described in detail herein. The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein may be implemented in many different ways using a wide range of programming techniques as well as general purpose hardware systems or dedicated controllers. The program 206 may be stored in a compressed, uncompiled and/or encrypted format. The program 206 furthermore may include program elements that may be generally useful, such as an operating system, a database management system and “device drivers” for allowing the processor 200 to interface with computer peripheral devices. Appropriate general purpose program elements are known to those skilled in the art, and need not be described in detail herein.

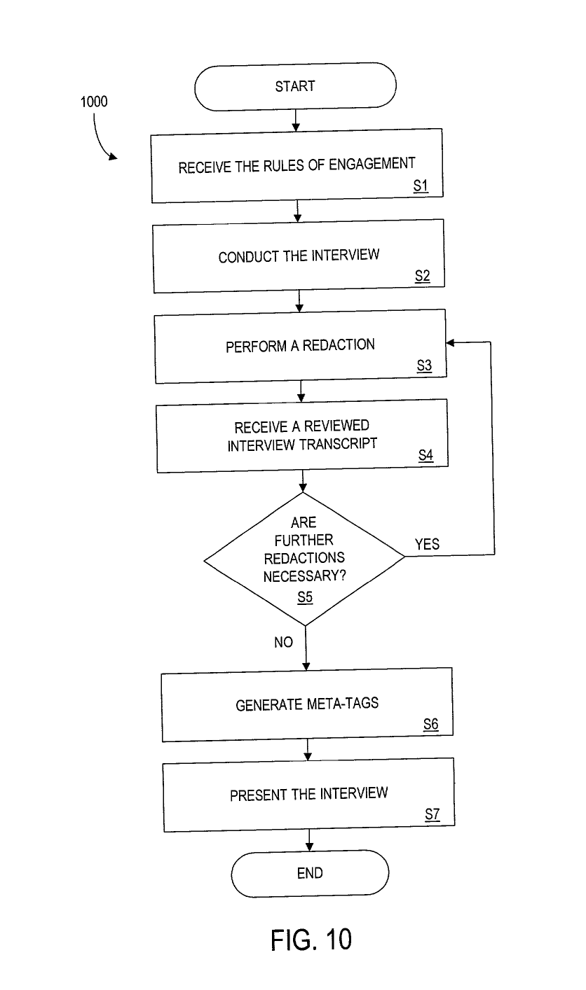

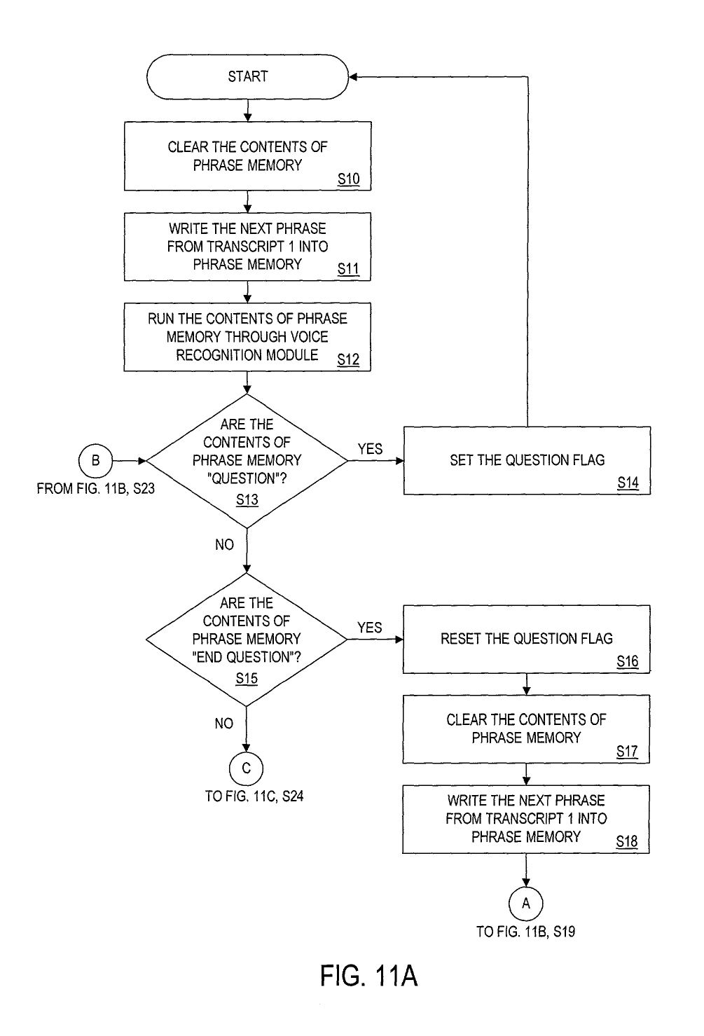

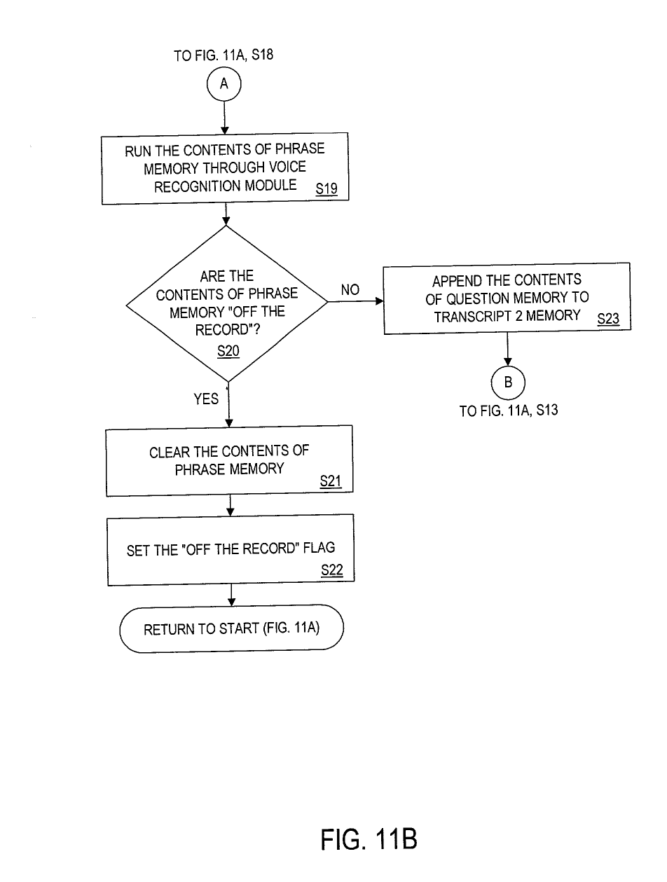

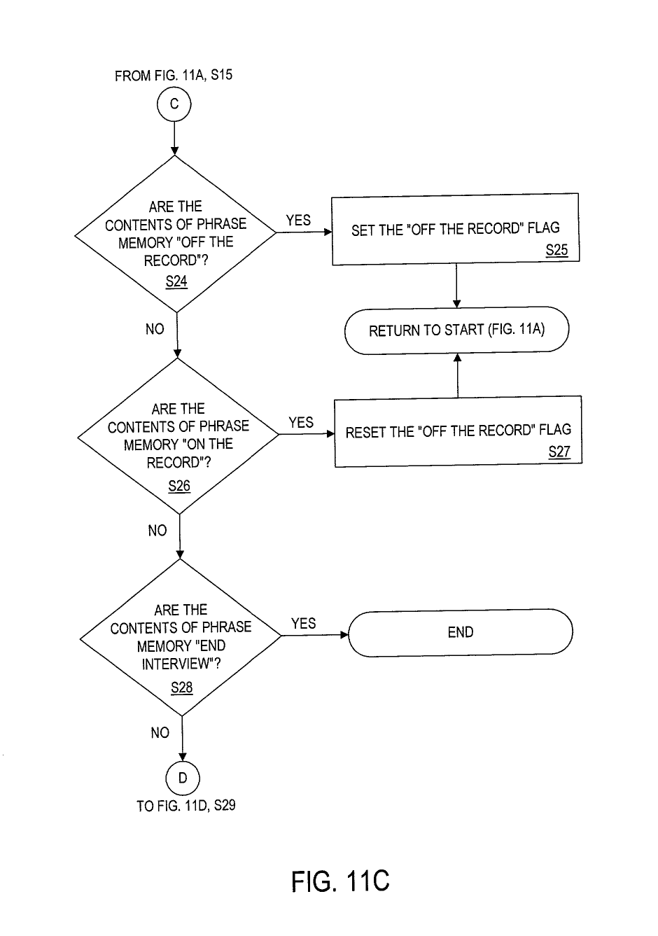

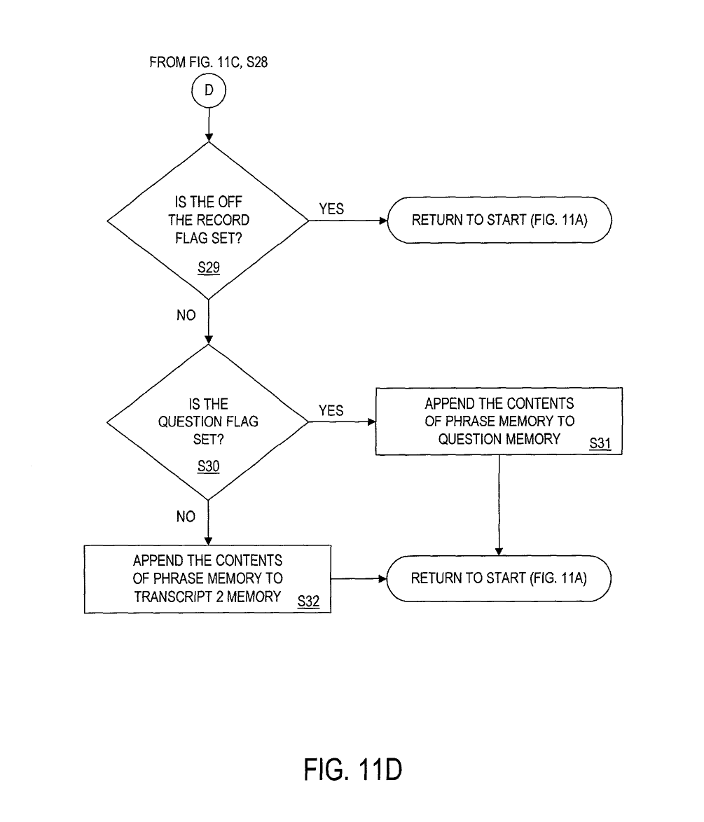

Further, the program 206 is operative to execute a number of invention-specific modules or subroutines including but not limited to one or more routines to upload, store, and organize recordings; one or more routines to redact recordings; one or more modules to recognize tags within recordings (e.g. voice recognition modules, image recognition modules, pattern recognition modules); one or more routines to generate meta-tags describing the redacted recordings; one or more routines to present redacted recordings for sale; one or more modules to implement a server for hosting Web pages; one or more routines to transact sales of information; one or more routines to download redacted recordings to user devices 104; one or more routines to receive information about a consumer; one or more routines to facilitate and control communications between recording devices 106, user devices 104, the controller 102, and/or a third party server 110; and one or more routines to control databases or software objects that track information regarding consumers, recordings, third parties, user devices 104, rules of engagement, meta-tags, tags, interviews, questions, and answers. Examples of some of these routines and their operation are described in detail below in conjunction with the flowcharts depicted in FIGS. 10 and 11.

According to some embodiments of the present invention, the instructions of the program 206 may be read into a main memory of the processor 200 from another computer-readable medium, such from a ROM to a RAM. Execution of sequences of the instructions in the program 206 causes processor 200 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 206, the storage device 204 is also operative to store (i) a rules of engagement database 208, (ii) an interview database 210, (iii) an interview questions database 212, and (iv) a user database 214. The databases 208, 210, 212, 214 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five, six, or more functionally equivalent databases. Similarly, the illustrated entries of the databases represent exemplary information only; those skilled in the art will understand that the number and content of the entries can be different from those illustrated herein. Further, despite the depiction of the databases as tables, an object based model could be used to store and manipulate the data types of the present invention and likewise, object methods or behaviors can be used to implement the processes of the present invention. These processes are described below in detail with respect to FIGS. 10 and 11.

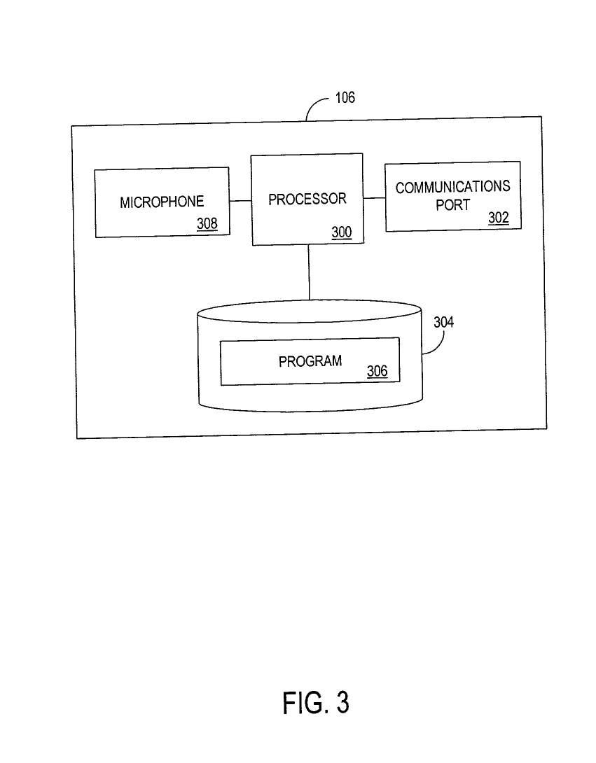

Turning to FIG. 3, a block diagram of an example recording device 106 is depicted. A recording device 106 according to the present invention may include a processor 300 coupled to a communications port 302, a data storage device 304 that stores a recording device program 306 and recordings, and a microphone 308. Although not pictured, a recording device 106 may include a video camera and/or any other type of input device capable of generating a signal that can be recorded. In addition, a recording device 106 may include a multi-tone sound generator that can be used to insert tones into a recording for use as tags. A recording device program 306 may include one or more routines to facilitate and control communications and interaction with the controller 102 as well as a user interface to facilitate making recordings. As indicated above, a recording device 106 may be implemented by any number of devices such as, for example, a tape recorder, a camcorder, a video cassette recorder, a digital video disc recorder, a telephone, an IVR system, a cellular/wireless phone, a security system, a television camera, a kiosk, a vending machine, a pager, a personal computer, a portable computer such as a laptop, a wearable computer, a palm-top computer, a hand-held computer, and/or a PDA.

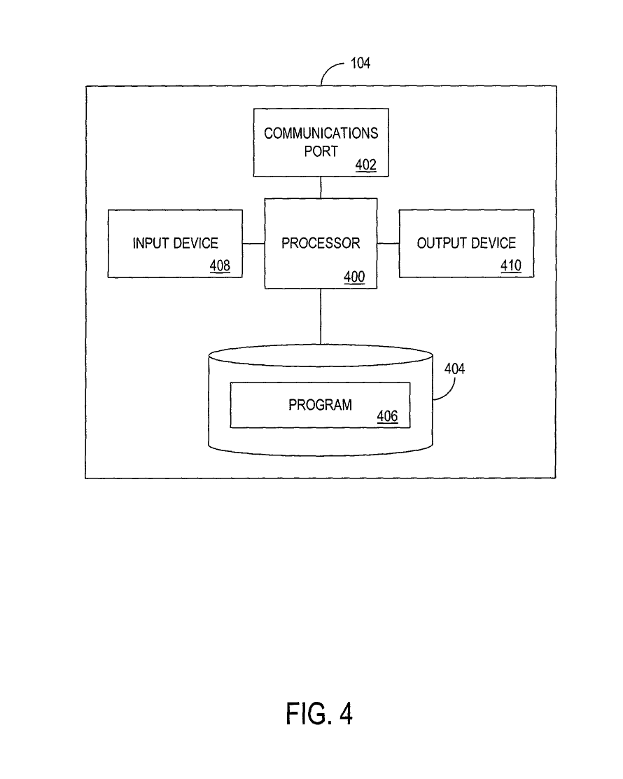

Turning to FIG. 4, a block diagram of an example user device 104 is depicted. A user device 104 according to the present invention may include a processor 400 coupled to a communications port 402, a data storage device 404 that stores a user device program 406, an input device 408, and an output device 410. A user device program 406 may include one or more routines to facilitate and control communications and interaction with the controller 102 as well as a user interface to facilitate communications and interaction with a consumer (e.g. an operating system, a Web browser, etc.).

In addition, a user device 104 may include additional devices to support other functions. For example, a user device 104 embodied in an ATM may additionally include a system for receiving, counting, and dispensing cash as well as a printing device for generating a receipt and/or a security camera. In another example, a user device 104 embodied in a gaming device may additionally include a system for generating and/or selling outcomes certified by a gaming authority. Such systems include slot machines which include conventional reel slot machines, video slot machines, video poker machines, video keno machines, video blackjack machines, and other gaming machines. In yet another example, a user device 104 embodied in a gasoline pump may additionally include a system for pumping, measuring, and managing the flow control of fuel. Further, many alternative input and output devices may be used in place of the various devices pictured in FIG. 4. Uses of these user device 104 components are discussed below in conjunction with the description of the methods of the present invention.

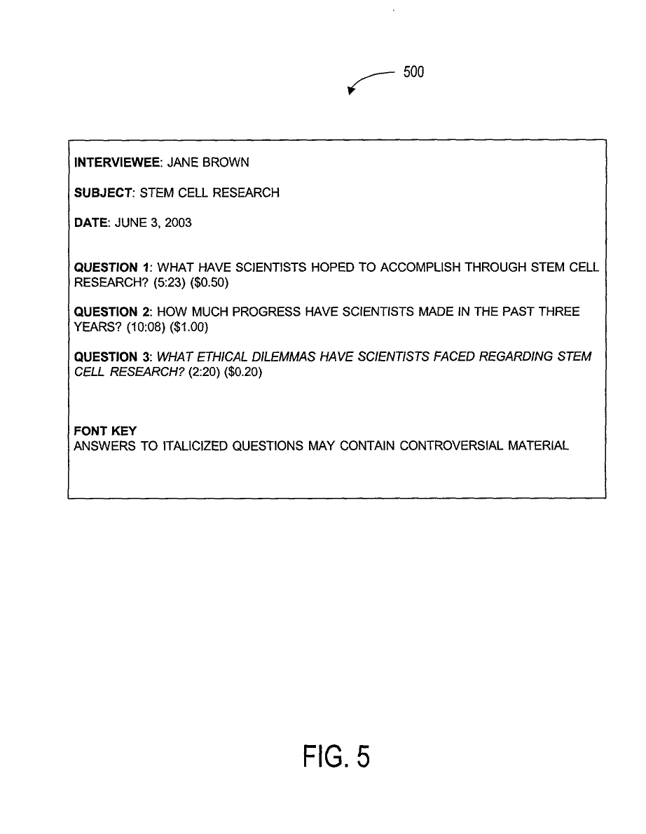

Turning to FIG. 5, an example screen image 500 of a user device 104 illustrating an example Web page view into the controller 102 is provided. The example image 500 displays meta-tags that provide information about an interview of “Jane Brown” regarding “Stem Cell Research” that took place on “Jun. 3, 2003.” Three separate links to three separate answers are displayed as questions. Following each question, a length of time of the response and a price to receive the recording of the response are displayed. By clicking on the questions of interest, a user may be taken to a page in which he may purchase and download the recording for the prescribed price. Note that according to the font key at the bottom of the image, the third question, which is in italics, “may contain controversial material.”

D. Databases

As indicated above, it should be noted that although the example embodiment of FIG. 2 is illustrated to include four particular databases stored in storage device 204, other database arrangements may be used which would still be in keeping with the spirit and scope of the present invention. In other words, the present invention could be implemented using any number of different database files or data structures, as opposed to the four depicted in FIG. 2. Further, the individual database files could be stored on different servers (e.g. located on different storage devices in different geographic locations, such as on a third-party server 110). Likewise, the program 206 could also be located remotely from the storage device 204 and/or on another server. As indicated above, the program 206 includes instructions for retrieving, manipulating, and storing data in the databases 208, 210, 212, 214 as necessary to perform the methods of the invention as described below.

1. Rules of Engagement Database

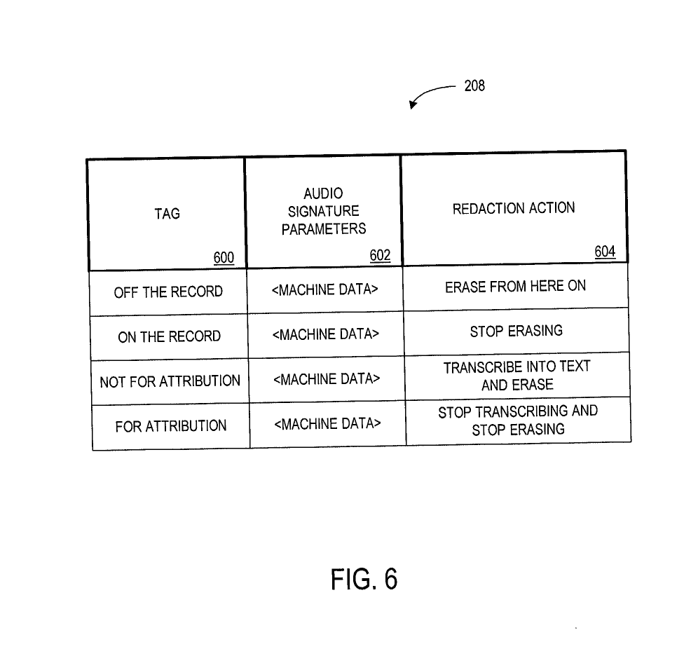

Turning to FIG. 6, a tabular representation of an embodiment of a rules of engagement database 208 according to some embodiments of the present invention is illustrated. This particular tabular representation of a rules of engagement database 208 includes four sample records or entries which each include information regarding a particular rule of engagement. In some embodiments of the invention, a rules of engagement database 208 is used to track such things as tags, data useful for the identification of tags, and redaction rules. Those skilled in the art will understand that such a rules of engagement database 208 may include any number of entries.

The particular tabular representation of a rules of engagement database 208 depicted in FIG. 6 defines a number of fields for each of the entries or records. The fields may include: (i) a tag field 600 that stores a representation uniquely identifying a tag; (ii) an audio signature parameters field 602 that stores a representation of machine data associated with the tag useful for identifying the given tag in an audio recording using pattern matching algorithms; and (iii) a redaction action field 604 that stores a representation of a description of the action that is to be taken in response to the given tag appearing in a recording.

The example rules of engagement database 208 depicted in FIG. 6 provides example data to illustrate the meaning of the information stored in this database embodiment. The information stored in a tag field 600 (e.g. “OFF THE RECOR”, “ON THE RECORD”, “NOT FOR ATTRIBUTION”, “FOR ATTRIBUTION”) may be used to identify the function of the tag. The information stored in audio signature parameters field 602 may be in the form of bit patterns that the redaction program 206 may use to identify tags in the recording. The information stored in the redaction action field 604 (“ERASE FROM HERE ON,” “STOP ERASING,” “TRANSCRIBE INTO TEXT AND ERASE,” “STOP TRANSCRIBING AND STOP ERASING”) includes a directive regarding how the recording should be modified for the associated tag. For example, when “OFF THE RECORD” is detected in a recording, the system 100A, 100B begins erasing the recording from that point forward. Once an “ON THE RECORD” tag is detected, the system 100A, 100B stops erasing the recording from that point forward.

2. Interview Database

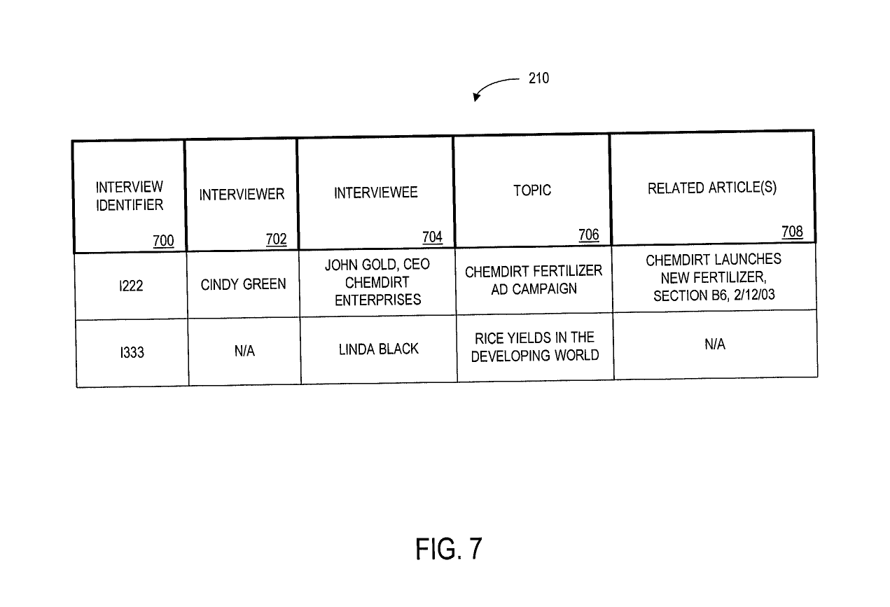

Turning to FIG. 7, a tabular representation of an embodiment of an interview database 210 according to some embodiments of the present invention is illustrated. This particular tabular representation of an interview database 210 includes two sample records or entries which each include information regarding a particular interview. In some embodiments of the invention, an interview database 210 is used to track interview recording information such as the interviewer's name, the interviewee's name, topics discussed and related information. Those skilled in the art will understand that such an interview database 210 may include any number of entries.

The particular tabular representation of an interview database 210 depicted in FIG. 7 defines a number of fields for each of the entries or records. The fields may include: (i) an interview identifier field 700 that stores a representation uniquely identifying a particular interview; (ii) an interviewer name field 702 that stores a representation of the interviewer's name; (iii) an interviewee name field 704 that stores a representation of the interviewee's name; (iv) a topic field 706 that stores a representation of a description of topic of the interview; and (v) a related articles field 708 that stores a representation of a description of articles relevant to the topic and/or interviewee.

The example interview database 210 of FIG. 7 provides example data to illustrate the meaning of the information stored in this database embodiment. An interview identifier 700 (ie. 1222, 1333 ) may be used to identify and index recorded interviews conducted according to a known set of rules of engagement, for example, those depicted in the example rules of engagement database 208 of FIG. 6.

The first sample entry describes a interviewer named “Cindy Green,” who interviewed “John Gold, CEO, Chemdirt Enterprises.” The topic of the interview was the “Chemdirt Fertilizer Ad Campaign” and a related article entitled “Chemdirt Launches New Fertilizer, section B6, 2/12/03” is identified. Note that the related article is likely to be the original information product that necessitated the interview of John Gold. In other words, the related article will likely describe the John Gold interview and possibly quote him. However, it is unlikely that the entire contents of the interview could be included in the related article. Thus, the related article may include a fee-based link to the redacted version of the interview for readers willing to purchase more details or possibly purchase a recording of the entire redacted interview.

The second sample entry describes a recording of “Linda Black” talking about “rice yields in the developing world.” No interviewer is identified which may indicate that the recording is of a speech without an interviewer. Likewise the absence of a related article may indicate that no article was or will be written based on Ms. Black's speech. Alternatively, the related article may still be in preparation and just has not been published yet.

3. Interview Question Database

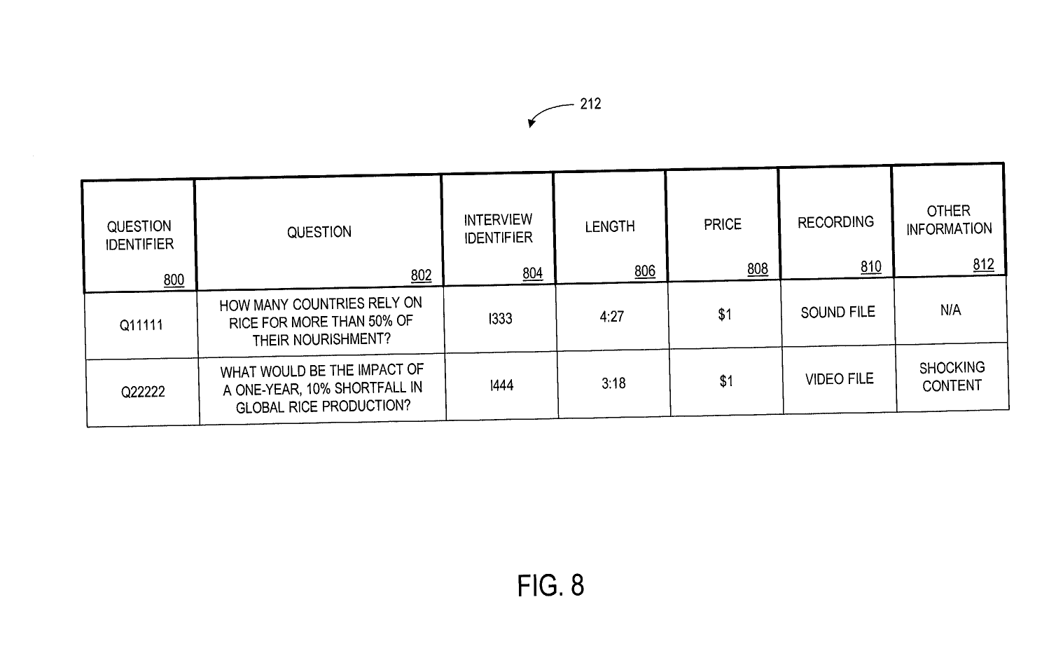

Turning to FIG. 8, a tabular representation of an embodiment of a interview question database 212 according to some embodiments of the present invention is illustrated. This particular tabular representation of a interview question database 212 includes two sample records or entries which each include information regarding a particular interview question. In some embodiments of the invention, an interview question database 212 is used to track information about the interview questions including who asked the question when, the length of the response, the price to receive a copy of the response, the format of the response, and other information. Those skilled in the art will understand that such a interview question database 212 may include any number of entries.

The particular tabular representation of a interview question database 212 depicted in FIG. 8 defines a number of fields for each of the entries or records. The fields may include: (i) a interview question identifier field 800 that stores a representation uniquely identifying the interview question; (ii) a question field 802 that stores a representation of the actual question; (iii) an interview identifier field 804 that stores a reference back into the interview identifier field 700 of the interview database 210 of FIG. 7; (iv) a length field 806 that stores a representation of the amount of time of the response; (v) a price field 808 that stores a representation of the price to receive a copy of the redacted recorded response to the question; (vi) a recording field 810 that stores a representation of the format of the recording of the response; and (vii) an “other information” field 812 that stores a representation of descriptive information regarding the response.

The example interview question database 212 of FIG. 8 provides example data to illustrate the meaning of the information stored in this database embodiment. A question identifier 800 (e.g. Q1 1111, Q22222) may be used to identify and index the different questions listed in the interview question database 212. The question “How many countries rely on rice for more than 50% of their nourishment?” was posed to Linda Black during interview number “1333.” Her response was “four minutes and twenty-seven seconds” long and it is available for download for “$1.00.” The question “What would be the impact of a one-year 10% shortfall in global rice production?” was posed to an unidentified interviewee and the response, which is “three minutes and eighteen seconds long” and contains “shocking content” is available for purchase in “video” format for “$1.00.” Note that the unidentified interviewee may be intentionally unidentified because the question may have been associated with a “not for attribution” tag.

4. User Database

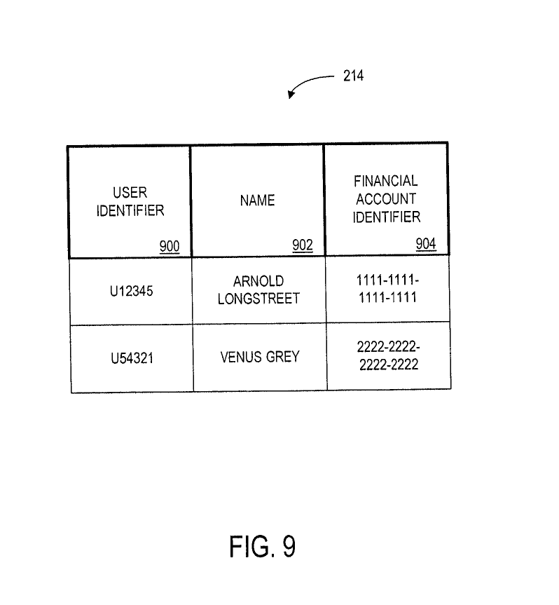

Turning to FIG. 9, a tabular representation of an embodiment of a user database 214 according to some embodiments of the present invention is illustrated. This particular tabular representation of a user database 214 includes two sample records or entries which each include information regarding a particular user. In some embodiments of the invention, a user database 214 is used to track such things as the user names and their associated financial account information. Those skilled in the art will understand that a user database 214 may include any number of entries.

The particular tabular representation of a user database 214 depicted in FIG. 9 defines three fields for each of the entries or records. The fields may include: (i) a user identifier field 900 that stores a representation uniquely identifying at least one user; (ii) a name field 902 that stores a representation of the user's name; and (iii) a financial account identifier field 904 that stores a representation the user's credit card or bank account number, for example.

The example user database 214 of FIG. 9 provides example data to illustrate the meaning of the information stored in this database embodiment. A user identifier 900 (e.g. U12345, U54321) may be used to identify and index the different users listed in the user database 214. “Arnold Longstreet” with credit card number “1111-1111-1111-1111” and “Venus Gray” with credit card number “2222-2222-2222-2222” are the two users listed in the example user database 214 of FIG. 9.

E. Process Description

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the invention's methods. The system described above is an example of a system that would be useful in practicing the invention's methods. For example, the user database 214 described above is useful for tracking user, but it is not absolutely necessary to have such a database in order to perform the methods of the invention. In other words, the methods described below may be practiced using a conventional customer list.

Referring to FIG. 10, a flow chart is depicted that represents some embodiments of the present invention that may be performed by the controller 102 (FIGS. 1A and 1B), an external third party, and/or an integrated third party entity/device such as a third-party server 110. It must be understood that the particular arrangement of elements in the flow chart of FIG. 10, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 10, the method steps of the present invention may be summarized as follows. In Step S1, rules of engagement established by the subjects are received by the system 100A, 100B. In Step S2, an interview of the subjects conducted according to the rules of engagement is recorded. In Step S3, the recording is redacted by the system 100A, 100B. In Step S4, a reviewed version of the redacted recording is received by the system 100A, 100B. In Step S5, a determination is made whether further redaction is necessary: if so, the process loops back to Step S3 where the system 100A, 100B redacts the reviewed recording. Otherwise the process proceeds to Step S6, where meta-tags descriptive of the recording are created, and then to Step S7 where the redacted recording is presented for sale, for example, as displayed in FIG. 5.

In the subsections that follow, each of these seven steps will now be discussed in greater detail. Note that not all seven of these steps are required to perform the method of the present invention and that additional and/or alternative steps are also discussed below. Also note that the above general steps represent features of only some of the embodiments of the present invention and that they may be combined and/or subdivided in any number of different ways so that the method includes more or less actual steps. For example, in some embodiments many additional steps may be added to update and maintain the databases described above, but as indicated, it is not necessary to use the above described databases in all embodiments of the invention. In other words, the methods of the present invention may contain any number of steps that are practicable to implement the processes described herein. The methods of the present invention are now discussed in detail.

1. Receive The Rules Of Engagement.

In Step S1, rules of engagement established by the subjects are provided to the controller 102. If the recording will be of a speech by an individual subject, this step may merely involve defining a few tags to signal the beginning and end of topics. However, in the case of an interview, the interaction between an interviewer and an interviewee may be complicated. The interviewee may have certain points he wishes to get across, and other issues he wishes to avoid. Even when the interviewee wishes that information not be reported, he may be willing to give the information to the interviewer so that the interviewer has some background or perspective. Such information may be signaled using an “off the record” tag. Sometimes, the interviewee may wish to communicate information, but not wish to be reported as the source of the information. Such information may be signaled using a “not for attribution” tag.

The interviewer, on the other hand, typically wants as much information as possible, preferably “on the record”, and wants to be able to disclose his sources to the greatest degree possible. To convince a reluctant interviewee to be somewhat forthcoming, a interviewer may establish an agreement with the interviewee. The interviewer might say, for example, “Just answer the question for my own information, and I promise not to report any of it,” or, “That was good information. I'd like to use some of it. Can you restate your answer in a form that I could use?”

Similarly, the interviewee may propose agreements. “I'll answer that, but you must be sure to mention this other point too in your article.” At times, an interviewee might say something he did not intend to say, or may reconsider what he has already said. The interviewee may wish therefore to retract certain statements. The interviewer may allow the statements to be retracted, perhaps, if the interviewee will make an alternate statement on the same subject.

Since there may be a fairly complex interaction between the interviewer and the interviewee, certain rules of engagement may be established prior to the interview. The rules of engagement detail how information obtained in the interview will be used, and how the interviewee may signal this use. In some embodiments, an interviewee signals how information should be used by voicing a phrase, such as “off the record,” “not for attribution,” or “made a mistake.” According to the rules of engagement agreed to by the interviewer and the interviewee, the interviewer will honor these phrases by, for example, not making certain information publicly available. The precise meanings of these phrases are described in more detail below.

In some embodiments, it is the responsibility of the controller 102 to honor these rules of engagement by, for example, removing certain portions of an audio transcript of an interview. In such embodiments, the controller 102 recognizes signaling phrases and responds appropriately based upon a redaction action associated with each signaling phrase, as, for example, in the rules of engagement database 208 of FIG. 6. Thus, in Step S1 of the present invention, a voice recognition module of the controller 102 may be taught to recognize certain key signaling phrases, called “tags,” in the recording of the interview. A database such as that of FIG. 6 may store sets of parameters corresponding to the audio signature of each potential tag. There are many methods known in the art for determining these parameters and for performing voice recognition. The database may also store instructions for the controller 102 to perform upon it recognizing the tag within the recording.

In some embodiments, the interviewer may repeat a tag after the interviewee has voiced the tag. A voice recognition module may be specifically trained to recognize the interviewer's voice, and so may more accurately identify tags if the interviewer repeats them after the interviewee.

2. Conduct The Interview

Once the interviewer and the interviewee have agreed on the rules of engagement, in Step S2, the interviewer activates a recording device 106 and begins the interview. During the course of the interview, the interviewer may voice key words or phrases that act as tags for the redacting process. Some possible tags include: question, end question, off the record, on the record, not for attribution, for attribution, etc.

In other words, an interviewer may voice the word “question” prior to asking a distinct question. When the controller 102 executes the redacting and subsequently reviews the recording of the interview, the system 100A, 100B recognizes the word “question” and responsively transcribes the question that follows. The interviewer may also voice the phrase “end question” immediately after asking a question. This allows the redacting process to know when to stop transcribing.

The pair of tags, “off the record” and “on the record”, may be voiced by the interviewer to indicate when the following information can and cannot be revealed to the public. Likewise, the pair of tags, “not for attribution” and “for attribution,” may indicate when the following information may and may not be permitted to be attributed to the interviewee.

Although specific tags have been described above, many other words or phrases may be used in their stead. Nonsensical words or phrases may even be used if these are easier for the software to understand. Nonsensical tags have the further advantage of being unlikely to occur during normal conversation. This would reduce the possibility of the redacting software confusing the word “question” for a tag even if the word occurs in normal conversation.

Although verbal tags have been described, other tags are possible. For example, rather than voicing the word “question,” the interviewer may press a tone generating button on the recording device prior to asking a question. The recording device may then store a beep or other sound at that point in the recording.

In general, tags may be voiced by the interviewer, the interviewee, a third-party, or even a device. As mentioned above, it may be effective for a interviewer to repeat a tag already voiced by an interviewee, because the interviewer's voice is more easily recognizable to the redacting process. During, or after the interview, the recording may be transferred to the controller 102. In some embodiments, the recording is initially on an audio cassette tape. After the interview, the audio cassette tape may be removed from the recording device 106 and inserted into a tape-playing input component of the controller 102. In other embodiments, the interview may be recorded using a cell phone or other wireless device as the recording device. The cell phone may then transfer the recording, in real time, to a recording component of the controller 102. For example, the interview may be recorded by a cell phone and transmitted into a voice mail box associated with the controller 102.

3. Perform A Redaction

In Step S3, the redaction process is executed on the controller 102. Unacceptable or inappropriate portions of the recording may be removed from the transcript of the interview so that the recording may be sold to the public. Unacceptable portions of the interview may include parts that were off the record, and parts that were not for attribution. Parts of the interview that suggest that later parts were off the record may also be removed. For example, the interviewer may ask a question, and the interviewee may signal, “off the record,” before answering. If the question remains in the recording, but the answer to the question is removed because of its being tagged as off the record, then there remains the implication to a listener that the question was answered off the record. Thus, the question and the answer may be removed from the recording in the redaction process.

The redaction process may also remove offensive language, redundant language, irrelevant language, excessive pauses, incidental noises, and so on. The redaction process may remove portions of audio where the interviewee has made a misstatement, for example, and wishes such portions to be removed. Redaction may be performed using hardware, software, human operators, or any combination of the three.

A simplified, step by step description of an example redaction process is provided below. This example redaction process uses four distinct memory spaces: Transcript 1 memory, Transcript 2 memory, Phrase memory, and Question memory. As with all systems of the present invention, these four memory spaces maybe implemented using hardware, software, or a combination of both. In this example, Transcript 1 memory is used to store the raw recording, Transcript 2 memory initially starts empty and is used to store the redacted recording as it is created, Phrase memory is used to temporarily store phrases sequentially taken from the raw recording in Transcript 1 memory as they are processed, and Question memory initially starts empty and is used to temporarily store questions until they are appended to Transcript 2 memory at the appropriate time. Once a phrase is loaded into Phrase memory it is analyzed to identify any tags using a voice recognition module. Methods of identifying specific terms in a string of spoken words are well known. For example, see “Speech and Language Processing: An Introduction to Natural Language Processing, Computational Linguistics and Speech Recognition” by Dan Jurafsky et al., published by Prentice Hall; ISBN: 0130950696; (Jan. 18, 2000) which is hereby incorporated by reference. Typically, the contents of Phrase memory will be immediately appended to Transcript 2 memory. However, if the content of Phrase memory is a tag, such as “question” or “off the record”, then the content of Phrase memory is not appended to Transcript 2. Rather, a flag is set or reset in accordance with the tag.

The contents of this Question memory are later by appended to the Transcript 2 memory unless the answer to the question is off the record. Otherwise, the contents of the Question memory are discarded.

In addition, this example redaction system and process uses two binary flags. The first flag indicates whether the current portion of a recording in Phrase memory is part of a question or not. A second flag indicates whether the current portion of a recording in Phrase memory is on the record or not. For example, when the system encounters a “question” tag in the recording, then the Question flag is set. When the system encounters an “end question” tag in the recording, the Question flag is reset. While the Question flag is set, the contents of Phrase memory are appended to Question memory rather than to Transcript 2 memory. This is so that the question can later be discarded without being added to transcript 2 if the answer turns out to be “off the record.”

The following “pseudo-code” segment provides an implementation of the example redaction process:

Start:
Clear the contents of Phrase memory
Write the next phrase from Transcript 1 into Phrase memory
Run the contents of Phrase memory through voice recognition module
If the contents of Phrase memory are “question”
Set the Question flag
Go back to Start
If the contents of Phrase memory are “end question”

Reset the Question flag
Clear the contents of Phrase memory
Write the next phrase from Transcript 1 into Phrase memory
Run the contents of Phrase memory through voice recognition module
If the contents of Phrase memory are “off the record”

Clear the contents of Question memory
Set the Off the record flag
Go back to Start

Otherwise (if the contents of Phrase memory are anything other than

“off the record”)

Append the contents of Question memory to Transcript 2 memory
Go back to “If the contents of Phrase memory are ‘question’”

If the contents of Phrase memory are “off the record”

Set the Off the record flag
Go back to start

If the contents of Phrase memory are “on the record”

Reset the Off the record flag
Go back to start

If the contents of Phrase memory are “end interview”

End

Otherwise (if the content of Phrase memory is not a tag),
If the Off the record flag is set

Go back to Start

If the Question flag is set
Append the contents of Phrase memory to Question memory.
Go back to Start
Otherwise (if the content of Phrase memory is not a tag, and no flags are
set),
Append the contents of Phrase memory to Transcript 2 memory
Go back to Start

Turning to FIGS. 11A to 11D, the above example redaction process is illustrated in a flow chart. In Step S10, the content of Phrase memory is cleared. In Step S11, the next phrase from Transcript 1 memory is written into Phrase memory. In Step S12, the content of Phrase memory is analyzed using a voice recognition module in an attempt to identify any tags. In Step S13, if the content of Phrase memory is a question tag, then the Question flag is set in S14 and the process returns to Step S10. Otherwise the process proceeds to Step S15 to determine if the contents of Phrase memory are an end question tag. If they are, the Question flag is reset in Step S16, the content of Phrase memory is cleared in Step S17, the next phrase from Transcript 1 memory is transferred into Phrase memory in Step S18, and the content of Phase memory is analyzed using a voice recognition module in an attempt to identify tags in Step S19. If, in Step S20, the content of Phrase memory is an off the record tag, then the contents of Phrase memory are cleared in Step S21, the Off the Record flag is set in Step S22, and the process returns to Step S10. Otherwise if, in Step S20, the content of Phrase memory is not an off the record tag, then the contents of Question memory are appended to Transcript 2 memory in Step S23 and the process returns to Step S13, if in Step S15, the contents of Phrase memory are not an end question tag, the process proceeds to Step S24 to determine if the content of Phrase memory is an off the record tag. If so, then the Off the record flag is set in Step S25 and the process returns to Step S10. If not, then in Step S26, it is determined if the content of Phrase memory is an end interview tag. If it is, then the process has completed. If not, then the process proceeds to Step S29 to determine if the Off the record flag is set. If it is the process returns to Step S10. If not, a determination is made in Step S30 if the Question flag is set. If it is, the content of Phrase memory is appended to Question memory in Step S31 and the process returns to Step S10. If not, then in Step S32 the contents of Phrase memory are appended to Transcript 2 memory and the process returns to Step S10.

The above example is of a greatly simplified redaction process and system. It does not perform several functions that are disclosed in the present invention. For example, the above description does not eliminate predefined four-letter words from the audio transcript. However, other functions may be readily incorporated into the above example implementation.

4. Receive A Reviewed Interview Transcript

Returning now to FIG. 10, in Step S4, the system receives back a reviewed recording. Once the redaction has been made, the modified recording may be submitted for review to one or more of the interviewer, the editor of the interviewer's paper, the interviewee, and/or a third party. This review reduces the likelihood that any tags were missed or misinterpreted in the redaction process. In some embodiments of the review process, an editor overlays new tags on top of the redacted recording. If there is a portion of the transcript that should have been left out, then the editor may voice and record the phrase “off the record” at the start of the portion of transcript to be left out. Similarly, the editor may voice and record the phrase “on the record” at the end of the portion of transcript to be left out. The new tags thereby become part of the redacted audio transcript. The editor may choose to overlay new tags on top of the raw transcript rather than the redacted transcript.

In other embodiments of the review process, the editor may manually redact the recording. Once again, this may be the raw transcript or the transcript already redacted by the software. As an example of a manual redaction process, the editor may play the raw audio transcript of the interview using an audio cassette player. At the same time, the editor may record the raw audio transcript onto another audio cassette using an audio cassette recorder. When the audio cassette that is playing reaches a portion of the interview that is off the record, the editor simply stops the recorder from recording. When the audio cassette that is playing then reaches a portion of the interview that is back on the record, the editor begins recording again. Many other methods of manual redaction are possible, and many other systems can be used for such a purpose.

5. Perform A Second Redaction If Necessary

Once the redacted audio transcript has been reviewed in Step S4, the controller 103 may determine in Step S5 that new tags have been added to the recording and a second redaction should be performed. If the editor has overlaid new tags atop one of the old recordings, then the controller 102 may perform the second redaction just as it did the first. After a second redaction, the editor may review the latest transcript. The process of redaction and review may be repeated any number of times until the editor is satisfied.

6. Generate Meta-Tags

In Step S6, meta-tags are generated. The term “meta-tag” refers to information about information. The underlying information is the recording of the interview. Information about the recording includes what questions were asked, how long the answers were, who the interviewee was, and so on. These meta-tags give a potential listener information about the interview before he commits money or time to listening to the actual recording. The following exemplary meta-tags may be generated from the recording during and/or after the redaction process:

(i) A textual transcription of a question that was asked by the interviewer. During the redaction process, the redacting system listens for “question” and “end question” tags. The audio that falls in between these tags is transcribed using a voice recognition module. It is not necessary that the textual transcription be perfect. Spelling and grammatical errors may be present. The transcribed question may be stored in a interview question database 212 such as that depicted in FIG. 8. The transcribed text of the question may later be displayed on a Web page hosted by the controller 102. The question may possibly be numbered, indicating how many questions were asked prior to it during the interview. A listener may click on the question in order to hear the response in audio format. In an alternate embodiment, the interviewer or other party may manually key in the question.

(ii) The length of the response to a question. The length may describe the duration of time that the interviewee spoke when answering the question. The length may also describe the number of words used by the interviewee in his response. During the redaction process, the redacting system may track the elapsed time between an “end question” tag and the next “question” tag. The elapsed time then, presumably, measures the length of the interviewee's response. The length of the response may be displayed, for example, next to the textual transcription of the question on the Web site hosted by the controller.

(iii) The price of listening to all or a portion of the interview. In some embodiments, an individual price is listed for the answers to each question in an interview. The price may typically depend on newspaper policy. If there is a predefined per-minute charge for listening, then the redacting software may determine the price of listening to an answer by first determining the length of the answer and then multiplying the length by the per-minute charge. In some embodiments, the price may simply be keyed in manually by an editor.

(iv) The nature of the content. Such a meta-tag may describe the content as vulgar, offensive, mature, graphic, controversial, and so on. During the redaction process, the voice recognition module may recognize key words or phrases from which it may derive an appropriate meta-tag. For example, the redacting software may describe the content of an answer as vulgar if it recognizes certain pre-defined four-letter words. Once again, a meta-tag such as “vulgar” may be displayed next to the textual transcription of a question. The tag may also be manually keyed in by an editor or other party who has listened the interview and made his own determination about the content.

(v) The name of the interviewee. In some embodiments, the interviewer voices the name of the interviewee on the audio transcript of the interview. The redacting software, in conjunction with a voice recognition module, may then transcribe the name and display the name with the interview. Since an interviewee may be sensitive to misspellings of his name, the transcribed name may be compared with a database of interviewee names in order to match the transcribed name with one from the database that is closest in spelling. In other embodiments, an editor or other party may key in the name of the interviewee.

(vi) The name of the interviewer. As with the name of the interviewee, the name of the interviewer may be voiced on the audio transcript of the interview, or may be manually keyed in by the editor. In some embodiments, the redacting software recognizes the source of the audio transcript and thereby recognizes the interviewer. For example, if the interview is recorded using the interviewer's cell phone, and transmitted to the interviewer's voice mailbox, then the redacting software may recognize the interviewer by his voice mailbox.

(vii) The subject of the interview. During the redaction process, the redacting system may pick out key words from the audio transcript and use these to print a subject heading for the interview. For example, the redacting software may pick out the words “education” and “congress” from a transcript and deduce that the subject of the interview is some legislation pertaining to education. More sophisticated methods for determining a subject heading, using artificial intelligence, are also possible. Again, a subject heading may also be keyed in manually.

(viii) The date of the interview. The date of the interview may automatically be incorporated into the audio transcript by the recording device that uses an internal calendar for reference. The redacting software may then recognize the date and create a date meta-tag for the interview.

(ix) A footnote that refers to the interview. The footnote will typically be displayed at the end of a newspaper article that uses a quote from the interview. A typical footnote might read, “For the full audio transcript of the interview with Sam Jones, go to http:/wwww.usatimes.com and type the code ‘b123400.’” A footnote may indicate any of the aforementioned meta-tags, such as the interviewee, the date of the interview, the subject of the interview, etc. The redacting software may communicate footnote information to editing software that assists with the layout of a newspaper. The editing software may then incorporate a the footnote in an article that references the interview.

(x) A note or a hyper-link that refers a listener of a first interview to other related interviews that have been archived. In one embodiment, if the redacting software has the name of the interviewee, then the software may search a database of archived interviews (FIG. 6) for other interviews of the same person. Then, on the Web page displaying information about the current interview, the software may create hyper-links to these related interviews. Many other relationships between current and former interviews are possible, besides having the same interviewee. Many other methods of referring a listener to an archived interview are also possible.

Meta-tags may be spelled out in words or may be presented in the form of colors, symbols, fonts, shading, etc. For example, an interview question whose answer contains graphic content may be transcribed in an italicized font. An interview question on the subject of justice may have a picture of a balance displayed next to the textual transcription of the question. If an answer to a question is both graphic and on the subject of justice, then the question may be presented in italicized form with a picture of a balance displayed alongside.

7. Present The Interview

Once the transcript of the interview has been redacted, reviewed, and all appropriate meta-tags have been generated, the interview transcript is made available to the public in Step S7. In some embodiments, meta-tags of the interview are posted on a Web site hosted by the controller 102. A potential listener can then access the interview using a browser such as Internet Explorer®. A potential listener may click on the meta-tags consisting of textual transcriptions of the interview questions. By clicking, the listener may activate an audio sound file containing a portion of the final transcript of the interview, and may thereby listen to the answer to the displayed question.

The listener may also be required to pay before listening to a portion of the interview. Clicking a meta-tag may bring the listener to a Web page where he can enter his credit card number and agree to pay the price of listening. The identities of paid listeners may be stored in user database 214 of FIG. 9, along with their financial account identifiers. Then, listeners who have already entered a credit card number need not do so a second time. Instead they may be given a password to use when paying to listen to interviews.

F. EXAMPLE ILLUSTRATIVE EMBODIMENT OF THE INVENTION

The following very specific example is provided to illustrate particular embodiments of the present invention, particularly from the perspective of the users of the system. A journalist named Jane interviewed Ivan, a prominent politician, on the subject of election finance reform. Before starting the interview, Jane told Ivan that if he would be uncomfortable answering any question on the record, he could simply say “off the record” and Jane would not report what he said. Jane then turned on her digital audio recorder and began the interview. She began by saying, “question” and then asked her first question: Why is campaign finance reform such a big issue this year? Jane then said, “end question.” John proceeded to answer the question, speaking for 6 minutes and 20 seconds.

Jane repeated the process of saying, “question,” asking her second question, and then saying, “end question.” However, this time, Ivan was uncomfortable answering on the record.

So Ivan began by saying, “off the record.” Jane repeated the phrase, and then Ivan gave Jane an answer for her own edification.

When Ivan had finished with his answer, Jane said, “on the record.” Now, once again, she said, “question,” asked her third question, and then said, “end question.” Ivan was comfortable answering and proceeded to do so for 3 minutes and 45 seconds. When Ivan was finished, he indicated that he had to leave for a meeting, so Jane said, “end interview.”

After interviewing Ivan, Jane took her digital audio recorder back to her office and uploaded the audio file containing the interview onto her PC. She then initiated a program to modify the interview and extract descriptors (meta-tags) for selling the interview to the public. The program, employing voice recognition technology, combed through the interview, searching for key phrases. When it encountered the word “question,” the program began transcribing the subsequent audio into text. It transcribed the following: “Why is campaign finance reform such a big issue this year?” Then the program encountered the phrase “end question,” and stopped transcribing. The program then noted the elapsed time between the phrase “end question” and the next occurrence of the phrase “question.” This time was recorded in memory as 6 minutes, 20 seconds.

The program transcribed the second question in a similar fashion, but then encountered the phrase “off the record.” The program then deleted the second question from the audio transcript, and deleted all subsequent audio until it encountered the phrase “on the record.” It then proceeded as before, transcribing the third question. When it encountered the “end interview” phrase, it was done analyzing the audio file.

The program then prompted Jane to enter the name of the interviewee and the subject of the interview. She did as asked. The program then generated a Web page containing interview information, including Ivan's name, the subject of the interview, and the two transcribed questions. Under each question was listed the time of the response and an icon that looked like an audio speaker. A price of four dollars was listed under the first question, and a price of two dollars under the second.

The program also had an output for Jane. If Jane referred to the interview in one of her future articles, she could add a footnote giving the Web address of the article: http://www.IvanInterview2.com.

Joe worked for an organization that was a major contributor to political campaigns. He read an article of Jane's where she quoted Ivan. Joe noticed the footnote at the end of the article that referred the reader to the full audio transcript of the interview with Ivan. The footnote listed the Web address, http://www.IvanInterview2.com. Joe logged on and went to the given address using his Web browser. At the Web site, Joe was able to see Ivan's name, the subject of the interview, and the two transcribed questions from the interview, along with the duration of the answers and the price of listening to the answers. Joe was interested in the first question asking why campaign finance reform was such a big issue. He clicked on the speaker icon under the first question. A screen then came up asking Joe to enter his credit card number so as to pay the price of four dollars for listening to the answer to the first question. Joe typed in his corporate account number and agreed to the charges. Then Windows Media Player® popped up on his screen, and began playing the audio answer to the first question.

G. Additional Embodiments of the Invention

The following are example alternative variations which illustrate additional embodiments of the present invention. It should be understood that the particular variations described in this section can be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

The present invention may include the additional step of verifying that the consumer is legally able to enter into an agreement to purchase the information. For example, an agreement may be legally unenforceable if the purchaser is under the age of 18. Thus, the controller 102 may, for example, consult a database of publicly available birth records. If the purchaser possesses an item, such as a credit card, that is given out on an restrictive basis, then the controller 102 may infer the purchaser's eligibility from the purchaser's possession of the item.

The present invention may include the additional step of alerting an interviewee that a consumer has purchased information related to that interviewee. In some embodiments, the interviewee or others may be interested in tracking the number of requests for a particular recording. In some embodiments, information may receive ratings based on how often it is purchased. The ratings may be used to promote additional sales of the information. In some embodiments, interviewers and interviewees may receive a percentage of revenues and or profits from the sale of recordings in which they participated.

In some embodiments users are permitted to subscribe to a service wherein the users are emailed all recordings related to a particular topic or involving a particular interviewee. For example, a user may want to purchase a subscription to every word their favorite celebrity says in an interview.

While the description of the invention has been illustrated using on audio and video interviews, the invention applies to any information that is supplementary to a news story or to any other primary source of information. Full text versions of an audio interview may be redacted and made available for reading by the public. Information that was originally conveyed in text format, such as an email message, may similarly be redacted and presented to the public for reading. The text of the email may even be converted to audio using voice synthesis or other technology. The present invention may be applied to supplementary video information as well. Portions of a video may be used as meta-tags in order to interest a potential viewer in watching the rest of the video.

In some embodiments, an interviewee may be willing to convey information but does not want the information attributed to him. The interviewer may use the tags “for attribution” and “not for attribution” in order to communicate the interviewee's desire to the redacting software. There is then the problem of presenting the information to the public without allowing the interviewee's voice to give away the source of the information. Thus, in some embodiments, information that is not for attribution is transcribed into text using a voice recognition module, before being presented to the public. In another embodiments, the information is presented in audio format, but a filter is applied to the audio so as to modify the sound of the interviewee's voice, and make it unrecognizable. Also, information that is not for attribution may be presented in a format unlike a typical question-answer format. The reason is that merely disguising the voice for one of many answers in an interview still leads a listener to believe that the disguised voice belongs to the same person as answered the other questions. Therefore, information that is not for attribution may be presented as background information for the interview rather than as part of the interview itself.

In other embodiments, additional tags for use during the interview include a “background” tag which represents information that may be included as an introduction to the interview, but may not be presented as if it was spoken by the interviewee. A “made a mistake” tag may be used when an interviewee realizes that he misstated some information and would like for the information not to be made available to the public.

In some embodiments a news organization may have dedicated staff members just for reviewing either raw or redacted interview transcripts to ensure nothing is made available to the public that should not be.

In some embodiments, a reference to an interview in a document may be a hypertext link, leading directly to the Web page on which the interview is displayed.

Some embodiments may include the additional step of archiving the interview, either raw or redacted, by storing it in an interview database.

In some embodiments, the rules of engagement may be voiced by an interviewer, interviewee, or third party, and recorded with the transcript of the interview. That way, there is a clear record of the rules of engagement. Furthermore, it may be clear that both the interviewee and the interviewer knew the rules of engagement. For example, if the interview transcript has the interviewee reading the rules of engagement and saying, “I understand,” then there is a clear record that the interviewee understood the rules of engagement. The clear record of the rules of engagement may aid in any subsequent dispute. In some embodiments, the record of the rules of engagement may be used by the controller 102 to customize a redaction process to accommodate the particular rules chosen.

In some embodiments, portions of an interview transcript may be removed because certain statements lack the proper context to be understood by a listener. Those statements might therefore be misunderstood and may lead to bad feelings. Therefore, one aspect of redaction may include the addition of contextual information to an interview transcript so that statements contained in the transcript might be better understood. The added information may be voiced by any person or by a machine or computer with voice synthesis capabilities. Contextual information may also appear as text alongside other meta-tags describing the interview.

In some embodiments, many factors may be considered in calculating the price of receiving all or a portion of a recording. These factors may include the length of the interview portion, the status or stature of the interviewee or interviewer, the relevance or value of the information discussed in the interview, the subject of the interview, the date, time, or location at which the interview was conducted, the subject, placement, length, or printing date of the article referencing the interview, the age, salary, net worth, place of employment, place of residence, purchasing history, or other information about the purchaser, the number of times the interview has been purchased already, ratings given to the interview or any party to the interview by purchasers or other critics. Subjective elements factoring into the price may be determined by the interviewee, the interviewer, the editor, a subject expert, or any other person or machine. For example, the editor of a paper may judge the importance of information contained in an interview.

In some embodiments, it may be desirable to discourage deceitful redactions. For example it may be desirable to discourage an associate of the interviewer from substituting a second question for a first question on the transcript, thereby making it appear that an interviewee has answered the second question rather than the first. Therefore, in some embodiments, an interviewee may record the interview session on his own, and keep for his own records the unaltered interview transcript. The interviewee may also be given a copy of the raw interview transcript. In other embodiments, the recording device may use various portions of the interview as input to a hash function. For example, the bit-representation of the first question and answer of the interview transcript may be used as input to a hash function, generating a single 32-bit sequence as output. The interviewee may be given the 32-bit sequence to keep for his records. If the first question and answer are later altered, then running the altered versions through the same hash function will most likely result in a different output, allowing the interviewee to demonstrate that an alteration took place. In still other embodiments, the digitized transcript of the interview may be digitally time-stamped, or digitally watermarked. Many other ways of discouraging alterations are possible.

H. Conclusion

It is clear from the foregoing discussion that the disclosed systems and methods to market supplemental information represents an improvement in the art of electronic commerce and automated processing and sales of information. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

What is claimed is:

1. A method comprising:
receiving at least one rule of engagement;
receiving a raw interview transcript of an interview conducted in accordance with the at least one rule of engagement;
performing a redaction of the raw interview transcript to generate a redacted interview transcript.

2. The method of claim A further including:
receiving a reviewed version of the redacted interview transcript; and
performing a redaction on the reviewed version.

3. The method of claim 1 further including generating meta-tags descriptive of the interview.

4. The method of claim 1 further including offering the redacted interview transcript for sale.

5. The method of claim 2 further including offering a redacted reviewed version for sale.

6. The method of claim 1 wherein receiving a raw interview transcript of an interview includes receiving an audio transcript of the interview.

7. The method of claim 1 wherein receiving a raw interview transcript of an interview includes receiving a text transcript of the interview.

8. The method of claim 1 wherein receiving a raw interview transcript of an interview includes receiving an video transcript of the interview.

9. A method of generating meta-tags for an interview comprising:
searching the interview transcript for tags;
extracting information from the transcript in accordance with predefined rules associated with the tags; and
storing the extracted information.

10. The method of claim 9 wherein the extracted information is presented using text.

11. The method of claim 9 wherein the extracted information is presented using a particular font.

12. The method of claim 9 wherein searching the interview transcript for tags includes searching the interview transcript for specific words.

13. The method of claim 9 wherein searching the interview transcript for tags includes searching the interview transcript for specific phrases.

14. The method of claim 9 wherein searching the interview transcript for tags includes searching the interview transcript for the word “question.”

15. The method of claim 9 wherein searching the interview transcript for tags includes searching the interview transcript for the word “name.”

16. The method of claim 9 wherein searching the interview transcript for tags includes searching the interview transcript for the word “date.”

17. The method of claim 9 wherein searching the interview transcript for tags includes searching the interview transcript for the word “subject.”

18. The method of claim 9 wherein searching the interview transcript for tags includes searching the interview transcript for the word “end interview.”

19. The method of claim 9 wherein extracting information from the transcript in accordance with predefined rules associated with the tags includes extracting information between two related tags.

20. A method of redacting an interview transcript comprising:
searching an interview transcript for tags; and
modifying the interview transcript in accordance with predefined rules associated with the tags.

21. The method of claim 20 wherein modifying the interview transcript includes removing at least one portion of the interview.

22. The method of claim 20 wherein modifying the interview transcript includes removing at least one portion of the interview if a tag associated with the at least one portion of the interview includes the phrase “off the record.”

23. The method of claim 20 wherein modifying the interview transcript includes removing at least one portion of the interview if the at least one portion of the interview includes profanity.

24. The method of claim 20 wherein searching an interview transcript for tags includes searching an audio transcript for audio tags.

25. The method of claim 24 wherein searching an interview transcript for tags includes identifying audio tags using at least one of voice recognition and speech recognition.

26. The method of claim 25 wherein identifying audio tags includes training a system to recognize at least one of a particular voice and at least one word.

27. The method of claim 20 wherein searching an interview transcript for tags includes searching a text transcript using text comparison.

28. The method of claim 20 wherein searching an interview transcript for tags includes searching a video transcript using image recognition.

29. A method of conducting an interview comprising:
recording a conversation; and
inserting at least one tag during the conversation,
wherein the at least one tag is inserted according to at least one predefined rule of engagement.

30. The method of claim 29 wherein inserting at least one tag includes inserting a tag that delineates a beginning of a question.

31. The method of claim 29 wherein inserting at least one tag includes inserting a tag that delineates an end of a question.

32. The method of claim 29 wherein inserting at least one tag includes inserting a tag that delineates a beginning of a response.

33. The method of claim 29 wherein inserting at least one tag includes inserting a tag that delineates an end of a response.

34. The method of claim 29 wherein inserting at least one tag includes inserting a tag that delineates a beginning of a portion of the conversation not to be made public.

35. The method of claim 29 wherein inserting at least one tag includes inserting a tag that delineates an end of a portion of the conversation not to be made public.

36. The method of claim 29 wherein inserting at least one tag includes inserting a tag that delineates a beginning of information not to be attributed to a person.

37. The method of claim 29 wherein inserting at least one tag includes inserting a tag that delineates an end of information not to be attributed to a person.

38. The method of claim 29 wherein inserting at least one tag includes inserting a tag that indicates that prior stated information is not to be made available to the public.

39. The method of claim 29 wherein inserting at least one tag includes generating a sound representative of a tag during the conversation.

40. The method of claim 29 wherein inserting at least one tag includes issuing a signal representative of a tag during the conversation.

41. The method of claim 29 wherein inserting at least one tag includes voicing a tag during the conversation.

42. The method of claim 41 voicing a tag includes repeating a voiced tag.

43. A system for presenting an interview for sale comprising:
a recording device for recording an interview conducted according to at least one rule of engagement;
recognition means for identifying at least one tag within a recording of the interview;
a processor operable to execute software for redacting the interview using the at least one tag to generate a redacted version of the interview; and
a server for posting the redacted version of the interview.

44. The system of claim 43 wherein the redacted version of the interview includes a text representation of at least one interview question and a recording of interview responses.

45. The system of claim 44 wherein the recording of interview responses includes at least one of audio information and video information.

46. The system of claim 43 wherein the server includes a website operable to execute transactions and to display at least one question and a representation of a response related to the question, and
wherein the website is further operable to provide the response in exchange for paying a price associated with the response.

47. The system of claim 46 wherein the website is further operable to display the price with the representation of the response.

48. The system of claim 43 wherein the server includes a website operable to execute transactions and display at least one question and a link to a response related to the question, and
wherein the website is further operable to permit access to the response in exchange for paying a price associated with the response.

49. The system of claim 48 wherein the website is further operable to display the price with the link to the response.

50. The system of claim 48 further including software executable by the processor to determine the price based upon characteristics of the response.

51. A method of presenting an interview comprising:
displaying at least one meta-tag descriptive of an interview; and
displaying a means for a user to select a portion of the interview to receive based on the meta-tag.

52. The method of claim 51 further including:
detecting a selection of a selected portion of the interview; and
presenting the selected portion of the interview to the user.

53. The method of claim 52 wherein presenting the selected portion includes providing the selected portion in at least one of audio format and video format.

54. The method of claim 51 wherein displaying at least one meta-tag includes displaying at least one meta-tag having a textual transcription of at least one interview question.

55. The method of claim 51 wherein displaying at least one meta-tag includes displaying at least one meta-tag having a descriptor of a nature of content of an associated portion of the interview.

56. The method of claim 55 wherein displaying at least one meta-tag having a descriptor of a nature of content includes displaying at least one meta-tag indicating that content of an associated portion of the interview is controversial.

57. The method of claim 51 wherein displaying at least one meta-tag includes displaying at least one meta-tag having a descriptor of the duration of an associated portion of the interview.

58. The method of claim 51 wherein displaying at least one meta-tag includes displaying at least one meta-tag having a descriptor of a price of receiving an associated portion of the interview.

59. The method of claim 51 wherein displaying at least one meta-tag includes displaying at least one meta-tag having a descriptor of the identity of an interviewee.

60. The method of claim 51 wherein displaying at least one meta-tag includes displaying at least one meta-tag having a descriptor of the identity of a journalist.

61. The method of claim 51 wherein displaying at least one meta-tag includes displaying at least one meta-tag having a descriptor of a subject of the interview.

62. The method of claim 51 wherein displaying at least one meta-tag includes displaying at least one meta-tag having a descriptor describing how to access the interview.

63. The method of claim 62 wherein describing how to access the interview includes providing a link to a website displaying a plurality of meta-tags, wherein some of the plurality of meta-tags are each associated with different portions of the interview.

64. The method of claim 62 wherein describing how to access the interview includes providing a link to the website of claim 47.

65. The method of claim 62 wherein displaying at least one meta-tag having a descriptor includes displaying at least one meta-tag as a footnote in an article quoting the interview.

66. The method of claim 62 wherein displaying at least one meta-tag having a descriptor includes displaying at least one meta-tag as a footnote in a report referencing the interview.

67. The method of claim 66 wherein the footnote includes a link to the website of claim 47.
